(19) United States
(12) Patent Application Publication
(10) Pub. No.: US 2008/0168030 A1
(43) Pub. Date: Jul. 10, 2008

(54) METHOD AND SYSTEM FOR IDENTIFYING AND SELECTING A WIRELESS DEVICE OR NETWORK FOR CONNECTION

(75) Inventor: Christopher M. Songer, Louisville, KY (US)

Correspondence Address: STITES & HARBISON, PLLC, 400 W MARKET ST, SUITE 1800, LOUISVILLE, KY, 40202-3352, US

(73) Assignee: STONESTREET ONE, INC., Louisville, KY (US)

(21) Appl. No.: 11/620,240

(22) Filed: Jan. 5, 2007

(51) Int. Cl. G06F 7/10; G06F 17/30

(52) U.S. Cl. 707/3; 707/E17.014

(57) ABSTRACT

A computer-based method and system for identifying and selecting a wireless device for connection comprises the steps of: using a computing device to receive data identifying each wireless device available for connection to the computing device in a given location; querying a database for information about each wireless device identified in the given location; determining connection requirements for the computing device; and selecting a wireless device for connection based on an analysis of the information about each wireless device available for connection to the computing device in the given location in view of the determined connection requirements.

### BACKGROUND OF THE INVENTION

The present invention is a computer-based method and system for identifying and selecting a wireless device or network for connection.

Computing devices are often connected to each other via wireless networks. For example, mobile computing devices, such as laptop computers, often look for and connect to wireless networks as they are transported from one location to another. To enable such connections, a variety of standards have been developed to govern how communications between the computing devices take place, including, for example, 802.11, Ultra Wideband (UWB) standards, and Bluetooth®. (Bluetooth® is a registered trademark of Bluetooth Sig, Inc. of Bellevue, Wash.) Each standard ultimately defines a way for two computing devices to exchange information wirelessly using a transmitter and a receiver (i.e., a radio) on each device, but the standards vary with respect to the technical characteristics of the communications (e.g., the frequency band, power, and modulation techniques). While many of the differences in technical characteristics are “invisible” to users, such differences may nonetheless directly affect the experience of the user. For example, depending on the communications standard that is used, latency (i.e., the amount of time between sending and receiving of information) and/or bandwidth (i.e., the amount of information that can be sent in a specified time period) may differ.

When two computing devices are connected with a cable, the connection of the cable clearly defines how the computing devices are to communicate. In other words, when a user chooses to take a cable and plug one end into one computing device and the other end into a second computing device, the user has decided which two computing devices will communicate. In wireless communications, there is no such tangible or clear expression of the user decision as to which devices will communicate. Software applications running on one or both of the computing devices must provide an analog to this decision as computing devices will often be equipped to communicate using multiple standards. Furthermore, each wireless standard typically allows for more that two computing devices to communicate simultaneously; thus, each of the standards allows for a computing device to recognize that there are multiple other computing devices to which it can connect.

With respect to technical issues, it should also be recognized that existing technologies generally do provide the user with some feedback with respect to signal strength. For example, in connections over an 802.11 network, each user (such as the user of a laptop computer attempting to connect to a wireless access point) is typically provided with a graphical representation of signal strength—a certain number of “bars.” Most users will associate a high signal strength with the reliability of the connection. However, the signal strength at a given time is not necessarily a good test of reliability because it does not take into account the reliability of the connection over time, and signal quality may also vary as a result of changes in the environment. For instance, the line of sight between two computing devices may be occasionally obscured, or periodic noise in the transmission band may interfere with communications. Furthermore, while the received signal strength at one end of the transmission may generally correlate with the received signal strength at the other end, such a presumed correlation is not always accurate.

Also, in wireless communications, there may be business or contractual differences with respect to how a computing device chooses to connect to another computing device or wireless network. For example, when a user is at an airport or other location that provides a wireless connection to the Internet, the user may be able to connect to a wide area network (WAN) for one predetermined cost or to a 802.11 network at a different cost.

Accordingly, selecting the optimal wireless device or network for connection becomes a complex problem, especially when the computing device is mobile and is being transported from location to location. Appropriate selection of a wireless device or network for connection requires an assessment of certain technical characteristics and well as consideration of relative costs.

### SUMMARY OF THE INVENTION

The present invention is a computer-based method and system for identifying and selecting a wireless device or network for connection.

A exemplary method for identifying and selecting a wireless device or network for connection in accordance with the present invention commences with a mobile computing device (such as a laptop computer) receiving data identifying each wireless device available for connection in a given location. Once data from the wireless devices has been received, a database is queried for information about each wireless device identified in the given location, including, for example, connection reliability versus signal strength for the particular type of radio; connection cost; performance data, including bandwidth and latency information; and user preferences. Once the information about each wireless device has been retrieved from the database, the next step is determining connection requirements. For example, a module resident on the computing device can be used to monitor the user's use of the computing device to determine what applications are currently running, how those applications are being used, and/or historical performance data in order to determine appropriate connection requirements, which generally would relate to the necessary bandwidth and latency. The final step is selecting a wireless device for connection based on an analysis of the information about each wireless device available for connection in the given location in view of the determined connection requirements.

To carry out the exemplary method described above, the mobile computing device may host a digital computer program that includes appropriate modules for executing the requisite instructions for performing the operational steps of the method: (a) a radio management module for receiving data identifying each wireless device available for connection to the computing device in a given location; (b) a user analysis module for monitoring the use of the computing device to determine what applications are currently running, how those applications are being used, and/or historical performance data, which leads to a determination of connection requirements; and (c) a selection module for querying the database for information about each wireless device identified in the given location and selecting one of the identified wireless devices based on an analysis of the information about each wireless device in the given location in view of the determined connection requirements.

### DESCRIPTION OF THE DRAWINGS

FIG. 1 is a flow chart illustrating an exemplary method for identifying and selecting a wireless device or network for connection in accordance with the present invention;

FIG. 2 is a flow chart illustrating one example of an appropriate selection process in accordance with exemplary method of FIG. 1; and

FIG. 3 illustrates an environment for a mobile computing device in which there are four radios/wireless devices available for connection.

### DETAILED DESCRIPTION OF THE INVENTION

The present invention is a computer-based method and system for identifying and selecting a wireless device or network for connection.

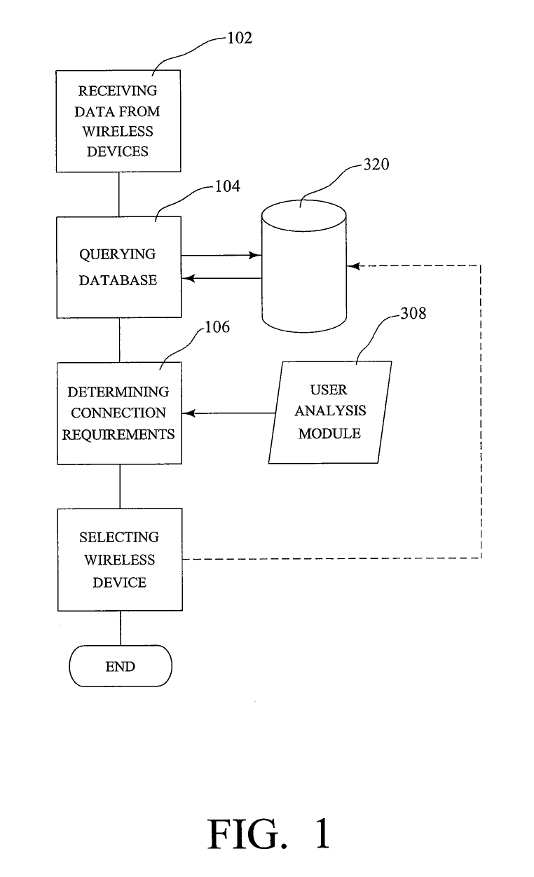

FIG. 1 is a flow chart illustrating an exemplary method for identifying and selecting a wireless device or network for connection in accordance with the present invention. As will become clear in the description that follows, the operational steps of this method are preferably achieved through the use of a digital computer program, i.e., computer-readable instructions stored and executed by a computer. Accordingly, the mobile computing device that is looking for and identifying each wireless device available for connection in a given location hosts a digital computer program stored on a computer-readable medium that includes appropriate modules for executing the requisite instructions. Such instructions can be coded into a computer-readable form using standard programming techniques and languages, and with benefit of the following description, such programming is readily accomplished by one of ordinary skill in the art.

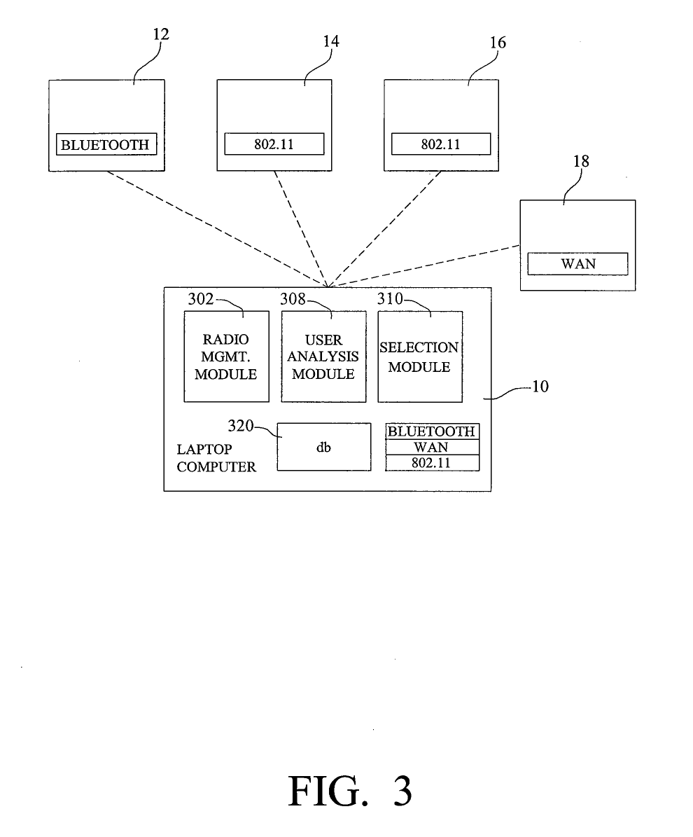

Referring still to FIG. 1, the method commences with a mobile computing device (such as a laptop computer) receiving data identifying each wireless device available for connection in a given location, as indicated by step 102. For purposes of example, reference is made to FIG. 3, which illustrates a laptop computer 10 that has a Bluetooth® radio, a WAN radio, such as an EvDO (Evolution Data Only) radio, and an 802.11 radio. There are four wireless devices available for connection to the laptop computer 10: a first access point 12 equipped with a Bluetooth® radio; a second access point 14 equipped with an 802.11 radio; a third access point 16 also equipped with an 802.11 radio; and a cellular WAN connection 18. In this regard, for purposes of the description and claims that follow, the term “wireless device” includes access points which allow for connection to a network. In any event, when the laptop computer 10 is turned on in this environment, it receives data from each of these wireless devices 12, 14, 16, 18, which preferably includes identifying information, such as: (a) the type of radio (Bluetooth®, 802.11, etc.); (b) the unique identifier of the radio (BD_ADDR for Bluetooth®, SSID for 802.11, etc.); and (c) signal strength information.

Referring again to FIG. 1, once data from the wireless devices 12, 14, 16, 18 has been received, a database 320 is queried for information about each wireless device identified in the given location, as indicated by step 104. The database 320 stores information about wireless devices, their technical characteristics, and costs associated with use. Specifically, in this exemplary implementation, the database 320 stores four discrete types of information: (a) connection reliability versus signal strength for the particular type of radio; (b) connection cost; (c) performance data, including bandwidth and latency information; and (d) user preferences.

Once the information about each wireless device 12, 14, 16, 18 has been retrieved from the database 320 (to the extent that such information is available and stored in the database), the next step is determining connection requirements, as indicated by step 106. In this regard, a module resident on the computing device (e.g., the laptop computer in this example) can be used to monitor the user's use of the computing device to determine what applications are currently running, how those applications are being used, and/or historical performance data in order to determine appropriate connection requirements, which generally would relate to the necessary bandwidth and latency. For example, if Microsoft Outlook® is the only application currently running on the computing device, and the user has historically used minimal bandwidth when running Microsoft Outlook®, a low bandwidth connection would satisfy the user's requirements. (Microsoft Outlook® is a registered trademark of Microsoft Corporation of Redmond, Wash.) Alternatively, connection requirements may be based solely on user preferences.

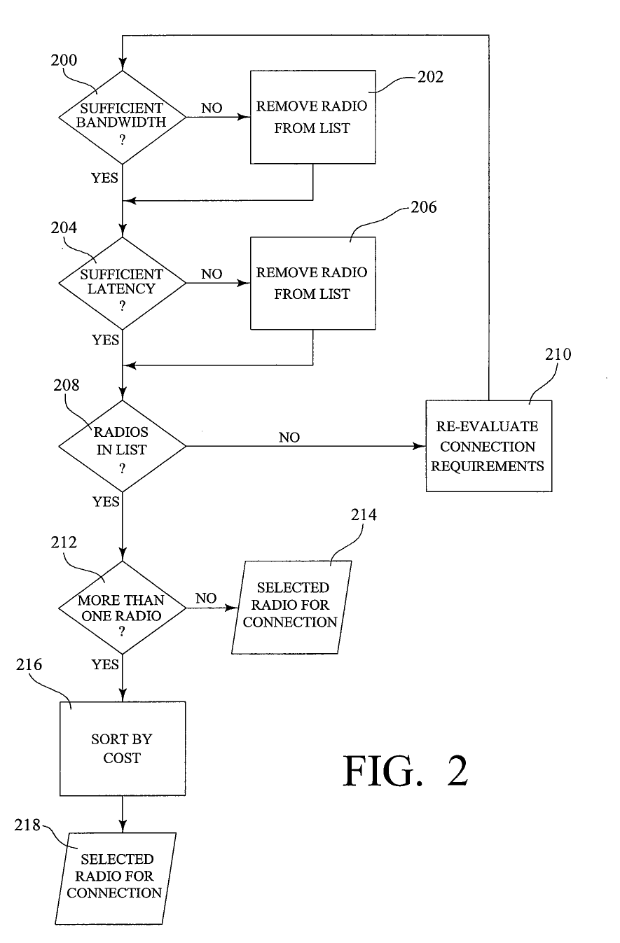

Referring again to FIG. 1, once the information about each wireless device 12, 14, 16, 18 has been retrieved from the database 320 and once the connection requirements have been determined, the next step is selecting a wireless device for connection based on an analysis of the information about each wireless device available for connection in the given location in view of the determined connection requirements, as indicated by step 110. Differing weights can be assigned to the discrete factors involved in the selection process and/or various constraints can be placed on the selection process based on user preferences. FIG. 2 is a flow chart illustrating one example of an appropriate selection process in accordance with exemplary method of FIG. 1.

As illustrated in FIG. 2, in this example, the first question is whether one or more of the radios associated with the identified wireless devices 12, 14, 16, 18 (in FIG. 3) provide a sufficient bandwidth, as indicated by decision 200. Each radio that does not have sufficient bandwidth is removed from the list of available radios, as indicated by step 202. The next question is whether one or more of the radios associated with the identified wireless devices 12, 14, 16, 18 (in FIG. 3) meet minimal latency requirements, as indicated by decision 204. Each radio that does not meet minimal latency requirements is removed from the list of available radios, as indicated by step 206. After these initial “filters” are applied, the next question is whether there are any radios that remain in the list, as indicated by decision 208. If not, the connection requirements must be re-evaluated and reset, as indicated by step 210, and the selection process would then start over. Alternatively, another technique may be utilized to select an appropriate radio/wireless device for connection if no radios remain in the list. Assuming that radios remain in the list of available radios, the next question is whether there is more than one radio in the list, as indicated by decision 212. If not, the one radio remaining in the list is selected as the radio/wireless device for connection, as indicated by output 214. If there is more than one radio in the list of available radios, then a subsequent sorting of the radios is performed, in this example, based on cost of the connection, as indicated at block 216. The lowest cost radio/wireless device is then selected for connection, as indicated by output 218.

Furthermore, as part of the selection process, user preferences may also be considered. For instance, although not shown in the Figures, if no available radios are identified that satisfy the bandwidth and latency requirements, a user could be prompted to make a selection. That selection could then be stored in the database 320, such that when the mobile computing device returns to the same environment, i.e., has the same combination of wireless devices available for connection, the database query described above with respect to FIG. 1 would result in an identification of the user's preferred selection. Indeed, as illustrated in FIG. 1, irrespective of how the radio/wireless device is ultimately selected, it is contemplated that the selection would be stored in the database 320 so historical selection could be factored into future determinations of the appropriate wireless device for connection.

FIG. 3 also illustrates the core components of an exemplary system for carrying out the method described above. The mobile computing device 10 hosts a digital computer program that includes appropriate modules for executing the requisite instructions for performing the operational steps of the method: (a) a radio management module 302 for receiving data identifying each wireless device available for connection to the computing device in a given location; (b) a user analysis module 308 for monitoring the use of the computing device to determine what applications are currently running, how those applications are being used, and/or historical performance data, which leads to a determination of connection requirements; and (c) a selection module 310 for querying the database 320 for information about each wireless device identified in the given location and selecting one of the identified wireless devices based on an analysis of the information about each wireless device in the given location in view of the determined connection requirements.

As an additional refinement to the method and system of the present invention, with respect to database 320 and the storage of information about connection reliability versus signal strength for each particular type of radio, it is contemplated that the digital computer program include a further connection validation module (not shown). As mentioned above, signal strength at a given time is not necessarily a good test of reliability because it does not take into account the reliability of the connection over time, and signal quality may also vary as a result of changes in the environment. Accordingly, a timer is incorporated into this connection validation module, which periodically triggers transmission of a request to one or more radios/wireless devices in a given location for a response. Such a request is medium specific but must require the radio to respond, so for example, for a connected 802.11 radio, an Address Resolution Protocol (ARP) request may be sent periodically to the IP gateway. If no response is received or a response is received with more than an acceptable number of errors, the request is deemed a failure. All success and/or failures can then be stored in the database 320 and be taken into consideration as part of the selection process described above.

One of ordinary skill in the art will recognize that additional embodiments are also possible without departing from the teachings of the present invention or the scope of the claims which follow. This detailed description, and particularly the specific details of the exemplary implementation disclosed, is given primarily for clarity of understanding, and no unnecessary limitations are to be understood therefrom, for modifications will become obvious to those skilled in the art upon reading this disclosure and may be made without departing from the spirit or scope of the claimed invention.

What is claimed is:

1. A computer-based method for identifying and selecting a wireless device for connection, comprising the steps of:
using a computing device to receive data identifying each wireless device available for connection to the computing device in a given location;
querying a database for information about each wireless device identified in the given location;
determining connection requirements for the computing device; and
selecting a wireless device for connection based on an analysis of the information about each wireless device available for connection to the computing device in the given location in view of the determined connection requirements.

2. The computer-based method as recited in claim 1, in which querying the database, determining connection requirements for the computing device, and selecting a wireless device for connection are accomplished through execution of a digital computer program resident on a computer-readable medium on the computing device.

3. The computer-based method as recited in claim 1, in which received data includes at least an identification of a type of radio associated with each wireless device and a unique identifier of the radio associated with each wireless device.

4. The computer-based method as recited in claim 3, in which received data further includes signal strength information.

5. The computer-based method as recited in claim 3, in which the information about wireless devices stored in said database includes technical characterstics.

6. The computer-based method as recited in claim 1, in which the step of determining connection requirements for the computing device includes an analysis of applications running on the computing device.

7. The computer-based method as recited in claim 1, in which the analysis of the information about each wireless device available for connection to the computing device in the given location includes the steps of:
determining whether one or more of the radios associated with the identified wireless devices available for connection provides a sufficient bandwidth;
determining whether one or more of the radios associated with the identified wireless devices available for connection meets minimal latency requirements; and
creating a list of radios that provide a sufficient bandwidth and meet minimal latency requirements.

8. The computer-based method as recited in claim 7, in which the analysis of the information about each wireless device available for connection to the computing device in the given location further includes the step of:
sorting the list of radios that provide a sufficient bandwidth and meet minimal latency requirements based on cost of connection.

9. A computer-based system for identifying and selecting a wireless device for connection, comprising:
a radio management module resident on a computer-readable medium of a computing device for receiving data identifying each wireless device available for connection to the computing device in a given location;
a user analysis module resident on the computer-readable medium of the computing device for monitoring use of the computing device to determine connection requirements; and
a selection module resident on the computer-readable medium of the computing device for querying a database for information about each wireless device identified in the given location and selecting one of the identified wireless devices based on an analysis of the information about each wireless device in the given location in view of the determined connection requirements.
